(19) United States
(12) Patent Application Publication
(10) Pub. No.: US 2026/0318521 A1
(43) Pub. Date: Oct. 15, 2026

(54) MODULAR LED LIGHTING FIXTURE WITH BEADED ROPE SEGMENTS

(71) Applicant: Kuzco Lighting LLC, Las Vegas, NV (US)

(72) Inventor: Nathan Yang, Surrey (CA)

(21) Appl. No.: 19/462,474

(22) Filed: Jan. 28, 2026

Related U.S. Application Data
(60) Provisional application No. 63/752,490, filed on Jan. 31, 2025.

(51) Int. Cl. F21V 23/06; F21S 4/26; F21Y 103/10; F21Y 115/10

(52) U.S. Cl. CPC F21V 23/06; F21S 4/26; F21Y 2103/10; F21Y 2115/10

(57) ABSTRACT

A modular lighting fixture assembly is disclosed. The assembly comprises a plurality of rope segments, each rope segment including a flexible sheath, a lighting assembly disposed at one end of the rope segment with at least one light emitting diode (LED), and at least one connector configured to electrically and mechanically couple to an adjacent rope segment. The assembly also includes at least one translucent bead configured to surround the lighting assembly and a first mounting segment configured to supply power to the plurality of rope segments and to secure the modular lighting fixture assembly to a surface. In some embodiments, the assembly includes a second mounting segment coupled to the opposite end of the modular lighting assembly, and the flexible sheath contains electrical conductors for transmitting power between adjacent rope segments.

### CROSS REFERENCE TO RELATED APPLICATION

This application relates to and claims priority from U.S. Provisional Application No. 63/752,490 filed on Jan. 31, 2025, the entirety of which is hereby incorporated by reference.

### TECHNICAL FIELD

This application relates to the field of lighting and lighting fixtures and/or interaction between the component parts of a lighting fixture assembly.

### BACKGROUND

Lighting fixtures have long been an essential component of interior and exterior design, providing both functional illumination and aesthetic appeal. Traditional lighting fixtures, however, often suffer from limitations in terms of customization, flexibility, and adaptability to various spaces. Many conventional lighting systems are designed for fixed installation in specific locations, limiting their versatility and ability to accommodate changing design preferences or spatial requirements.

As the demand for more versatile and customizable lighting solutions has grown, there is a need for innovative lighting systems that can be easily reconfigured, expanded, or adapted to suit diverse environments and user preferences. Such systems should ideally combine modularity, ease of installation, and aesthetic appeal while maintaining high-quality illumination and energy efficiency.

### SUMMARY

According to aspects of the present disclosure, a modular lighting fixture assembly is provided. The modular lighting fixture assembly includes a plurality of rope segments. Each rope segment comprises a flexible sheath, a lighting assembly disposed at one end of the rope segment, the lighting assembly comprising at least one light emitting diode (LED), and at least one connector configured to electrically and mechanically couple to an adjacent rope segment. The modular lighting fixture assembly also includes at least one translucent bead configured to surround the lighting assembly. The modular lighting fixture may include one or more mounting segments. The mounting segments may be configured to supply power to the plurality of rope segments and to secure the modular lighting fixture assembly to a surface.

The mounting segment may comprise a power supply unit configured to convert alternating current to direct current for powering the LEDs. The assembly may further comprise a controller configured to adjust brightness or color of the LEDs. The mounting segment may further comprise a strain relief element. The flexible sheath may house electrical conductors for transmitting power between adjacent rope segments. The translucent bead may be configured to diffuse light emitted by the lighting assembly. The modular lighting fixture assembly may be configurable into various lengths by connecting different numbers of rope segments.

### BRIEF DESCRIPTION OF THE DRAWINGS

For a better understanding of the embodiments described in this application, reference should be made to the Detailed Description below, in conjunction with the following drawings in which like reference numerals refer to corresponding parts throughout the figures.

FIG. 1 depicts an illustrative view of a portion of a modular lighting assembly showing the connection of a mounting segment and a rope segment in accordance with an embodiment.

FIG. 2 depicts an illustrative view of a portion of a modular lighting assembly showing the connection between two rope segments in accordance with an embodiment.

FIG. 3 depicts an illustrative view of a portion of a modular lighting assembly showing the connection of a mounting segment and a rope segment in accordance with an embodiment.

FIG. 4 depicts an illustrative view of a modular lighting assembly in accordance with an embodiment.

FIG. 5 depicts an illustrative view of a ceiling-mounted modular lighting fixture assembly in accordance with an embodiment.

FIG. 6 depicts an illustrative view of a wall-mounted modular lighting fixture assembly in accordance with an embodiment.

FIGS. 7-8 depict illustrative views of a wall-to-ceiling mounted modular lighting fixture assembly in accordance with an embodiment.

FIG. 9 is a diagram of an example computer system in accordance with certain aspects described herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the disclosures to these particular embodiments.

### Overview

The modular lighting fixture assembly described here may provide a versatile and customizable lighting solution that can be adapted to various spaces and design requirements. The assembly includes a plurality of rope segments that can be connected together to create a lighting fixture of desired length. In some examples, such rope segments may be flexible. In some examples, such segments may also be removed, reconnected, or replaced in an otherwise modular fashion as described. Such a modular design allows for flexibility in installation and configuration, enabling users to adjust the length of the lighting fixture by adding or removing rope segments as needed, change the light sources, replacing broken segments, and adapting the systems to different mounting surfaces.

In some cases, the modular lighting fixture assembly may include mounting segments at both ends of the connected rope segments. A first mounting segment may be configured to supply power to the plurality of rope segments and to secure the modular lighting fixture assembly to a surface, such as a wall or ceiling. A second mounting segment may be coupled to the opposite end of the modular lighting assembly, providing additional support and stability to the overall structure.

The rope segments that make up the modular lighting fixture assembly may contain lighting elements, such as Light Emitting Diodes (LEDs), and may be covered with and kind and shape of translucent materials to diffuse the light emitted by the lighting elements. In some embodiments, the rope segments may be flexible and/or moldable into various shapes. The flexible nature of the rope segments may allow the lighting fixture to be mounted on different surfaces and arranged in various configurations, adapting to different architectural features, engineering scenarios, and/or different design preferences. And with the modularity of the system, such arrangements may be changed, adapted, altered, updated, etc.

The modular nature of the assembly offers several advantages. Users may easily extend or shorten the lighting fixture by connecting or disconnecting rope segments. This feature may allow for quick adjustments to accommodate changes in room layout or lighting requirements without the need for complete replacement of the fixture. Alternatively, the modular nature of the assembly may allow for individual segments to be replaced as necessary. The rope segments may be made at different lengths such that they may be arranged in different patterns or adapted to different mountings.

In some cases, the mounting segment may house power supply components, such as transformers or drivers, to convert household electrical current into a form suitable for powering the lighting elements within the rope segments. The mounting segments may also incorporate features for securely attaching the assembly to various surfaces, ensuring safe and stable installation in different environments.

The modular lighting fixture assembly may be suitable for a wide range of applications, from residential spaces to commercial or hospitality settings. Its adaptability and ease of customization make it a versatile lighting solution for designers, architects, and end-users seeking flexible and aesthetically pleasing lighting options.

### Modular Segment Examples

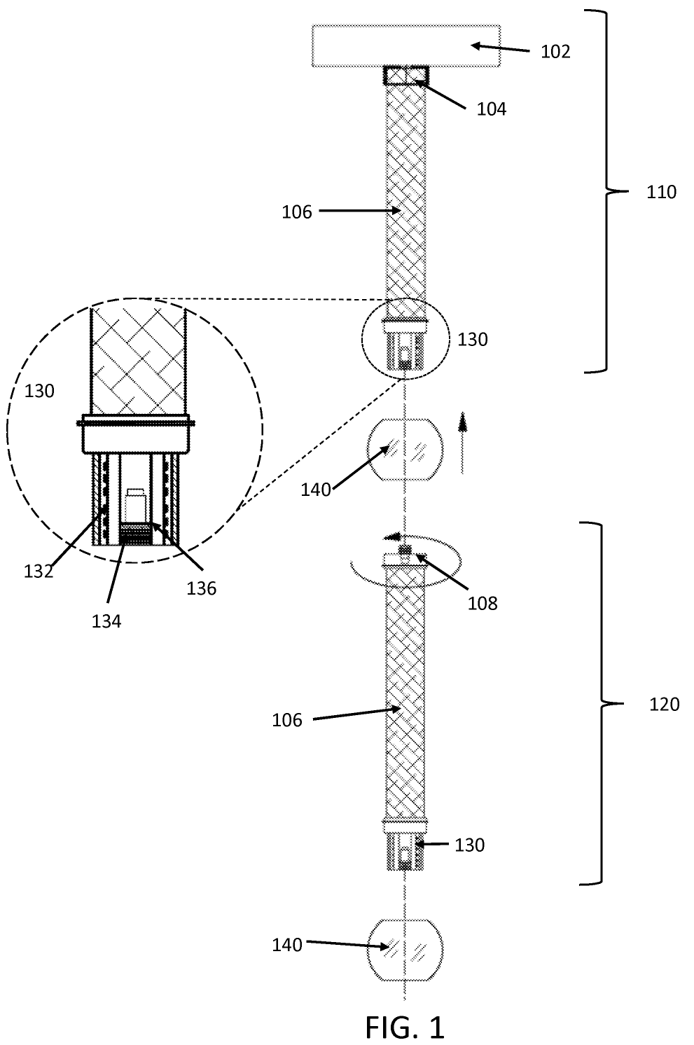

FIG. 1 depicts an illustrative view of a portion of a modular lighting fixture assembly showing the connection between a mounting segment and a rope segment. The assembly includes a mounting segment 110, which connects to a rope segment 120 through connectors 134/108.

The main structure of the modular lighting fixture assembly comprises a flexible sheath 106 that houses internal components. Such a flexible sheath 106 may be made of woven mesh material such as plastics, polymers, metals, carbon, or other strands of materials. In some examples, the flexible sheath 106 may be a smooth or textured flexible tube made of flexible material such as plastics, polymers, rubber, etc. In some examples, multiple layers of flexible material may make up the overall flexible sheath 106 with different flexible tubes within the main flexible sheath 106 as described herein.

In some examples, a rope strain relief 104 may be positioned where the flexible sheath 106 meets the mounting connection 102 on the mounting segment 110. The rope strain relief 104 may help prevent damage to the internal components of the rope segment 120 due to bending or tension, pulling or strain.

In some cases, each rope segment 120 may include a male connector 108 at one end for connecting to another segment. The male connector 108 may be configured to electrically and mechanically couple to a female connector 134 on another rope segment as described. In some examples, this connector 108/143 may be a threaded screw connector, or others as described herein.

A lighting assembly 130 may be integrated within the rope segment 120. The lighting assembly 130 may be disposed at one end of the rope segment 120. In some cases, the lighting assembly 130 may contain LEDs 132 and be electrically connected to wires running the length of the rope segment, inside the flexible sheath 106 and to the power coupling 130.

In some examples, the LEDs may be arranged in an annular format, wrapping around the light assembly 130 with the LEDs pointing out and away from the interior of the flexible sheath 106. In some examples, the LEDs may be arranged in rows, encircling the circumference of the connector 130. In some examples, the LEDs may be made of any color, programmed to blink, turn on and off, pulsate, flicker, change color, or otherwise programmable.

In some examples, the Wattage of the system may be about 76W. In some examples, the LEDs may be capable of Dimming between a Range of 100% - 10%. In some examples, such a dimming may include a type of TRIAC/ELV/010 compatible. In some examples, the Color Rendering Index (CRI) may be 90 CRI. In some examples, the LED Total Lumens may be 6700 lm. In some examples, the fixture delivered lumens may be 2430 lm. In some examples, the LED life span may be around 50,000 hours. In some examples, the fixture input voltage may be between 120-277V. In some examples, the illumination direction may be Omni-directional. In some examples, the LED Color Temperature may be 3000K. In some examples, the LED color temperature may be between 2500K and 3500K.

In some cases, the modular lighting fixture assembly 110/140 may be assembled by placing a translucent bead 140 over a lighting assembly 130 of a segment and coupling the segment to another segment, utilizing the complimentary connectors. A plurality of segments can be coupled in this way to form an assembly of a desired length. The completed assembly 110/140 may then be mounted and interfaced to external power and mounted on a ceiling, wall, or other structure(s) as described.

The LEDs 132 may serve as the primary light source for the modular lighting fixture assembly, with one at each connection point between rope lengths 120. In some examples, additional LED light sources may be positioned in different places on the rope length, not just at the terminal end of each length segment. In such examples, the LEDs may be arranged in a middle of the rope segment 120, at each end of the rope segment 120, at interspersed intervals along the rope segment. In some examples, the entirety of the rope segment 120 may be wrapped with LED lights such that it may all illuminate. Any various combination or permutation of the above may be created on different rope lengths and combined together with the connectors as described herein.

Conductors 136 may be present within the flexible sheath 106 for transmitting power between adjacent rope and/or mounting segments. These conductors 136 such as wires, may run along the length of the rope segment 120 from one terminal end 108 to the other 130, allowing for electrical connectivity throughout the assembly with however many lengths are connected and combined.

A female connector 134 may be provided at the opposite end of the rope segment 120 from the male connector 108. The female connector 134 may be configured for electrical connectivity between segments, allowing power and, in some embodiments, control signals to be transmitted along the length of the assembled fixture.

In some cases, the male 108 and female 134 connectors may couple via any of various connections. In some examples, a threaded connection may utilize complementary screw-like threads on the male and female connectors, allowing them to be securely fastened together by rotating one connector relative to the other. A snap connection, on the other hand, may utilize a protruding element on one connector that fits into a corresponding recess on the other connector, creating a secure connection with a resilient incline and receptor to snap together when properly engaged. Other types of connections that may be used include bayonet connections, push-fit connections, magnetic connections, twist-lock connections, friction-fit connections, pin-and-socket connections, and quick-release connections. Each of these connection types may offer different advantages in terms of ease of use, security of connection, and suitability for various environmental conditions or application requirements. In some examples, multiple connection types may be combined such as a magnetic snap connection or a twist fit pin-and-socket connection. Any combination of the above may be utilized.

In some examples, as shown in FIG. 1, translucent beads 140 may be positioned along the rope segment 120, surrounding the lighting assemblies 130. These translucent beads 140 may be configured to diffuse the light emitted by the LEDs 132, creating a softer, more uniform illumination. In some examples, these beads 140 may be made of different materials and/or colors to provide modular options to the designer. In such examples, different beads may be added, changed, adapted, or otherwise designed to fit different and changing design choices.

The detailed section view of FIG. 1 shows how the lighting assembly 130 may be constructed, with the LEDs 132, conductors 136, and connection components clearly visible. This construction allows for a modular design where multiple rope segments 120 can be connected together, both physically for support and also electrically for power and control, through the male connector 108 and female connector 134 system, while the translucent beads 140 provide light diffusion capabilities. Although the illustrated embodiment depicts the lighting assembly 130 as including the female connector 134, the LEDs 132 may be alternatively mounted in conjunction with the male connector 108, or both connectors.

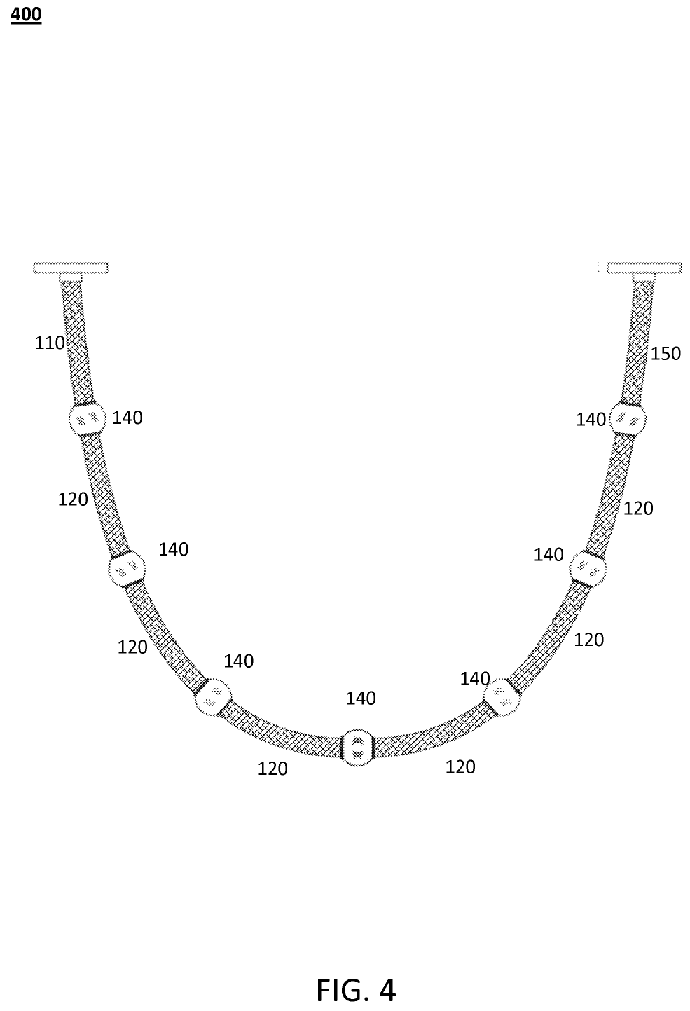

Such a coupling may not only support the weight of one or more rope segments 120 when connected together (see FIG. 4 for example) but may also provide the electrical connections needed to power the LEDs and command them to turn off and on, to change color, or otherwise change as programmed, as described herein.

In some examples, the maximum Fixture Dimension may have a Length of 196-7/8". In some examples, the diameter of the rope is about 2 and 3/8". In some examples, the diameter of the rope is about 2 ". In some examples, the diameter of the rope is about 3". In some examples, the diameter of the rope is between 1” and 3". In some examples, the diameter of the rope is between ½” and 4”. Rope and corresponding LED arrangements could be made in any sized diameter as described herein. In some examples, the cross section of the rope may be circular. In some examples, the cross section of the rope may be hexagonal shaped. In some examples, the cross section of the rope may be square shaped, or any other geometric shape.

The lighting assembly 130 and complementary connector 108 may include flanged portions configured for capturing or holding the translucent bead 140 when coupled.

In some examples, the surface mounting may allow for sloped ceiling mounts. In some examples, the materials of the system may include Aluminum and/or Steel for the hardware and Glass for the beads. In some examples, the glass beads may be Opal Glass.

### Segment Examples

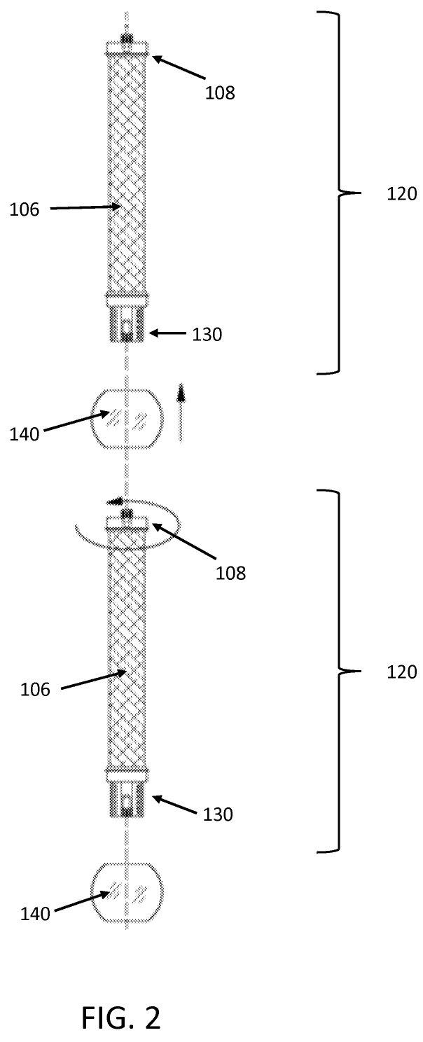

FIG. 2 depicts an illustrative view of a portion of a modular lighting fixture assembly showing the connection between two rope segments 120. Each rope segment 120 may include the flexible sheath 106 that extends along its length. The rope segments 120 may be configured to connect to each other through complementary male 108 and female 134 connectors positioned at their ends.

Each rope segment 120 includes the lighting assembly 130 that may be covered by a translucent bead 140. The translucent beads 140 are shown separated from their respective lighting assemblies 130, illustrating how they may be installed over the lighting elements. In some cases, the translucent beads 140 may be removable from the lighting assemblies 130.

The translucent beads 140 may be configured to diffuse light emitted by the lighting assemblies 130. This diffusion may help create a softer, more uniform illumination along the length of the modular lighting fixture assembly. In some embodiment, the translucent beads 140 may further filter the light to one or more colors.

The figure demonstrates how multiple rope segments 120 can be joined together to form a longer lighting assembly while maintaining electrical connectivity through the connectors 108/134. This modular design allows for customizable lengths of the lighting fixture, as users may add or remove rope segments 120 to achieve the desired overall length.

As described, any number of intermediary rope segments 120 may be placed between the two end rope segments that mount to a wall, ceiling, or other object.

### Mounting Examples

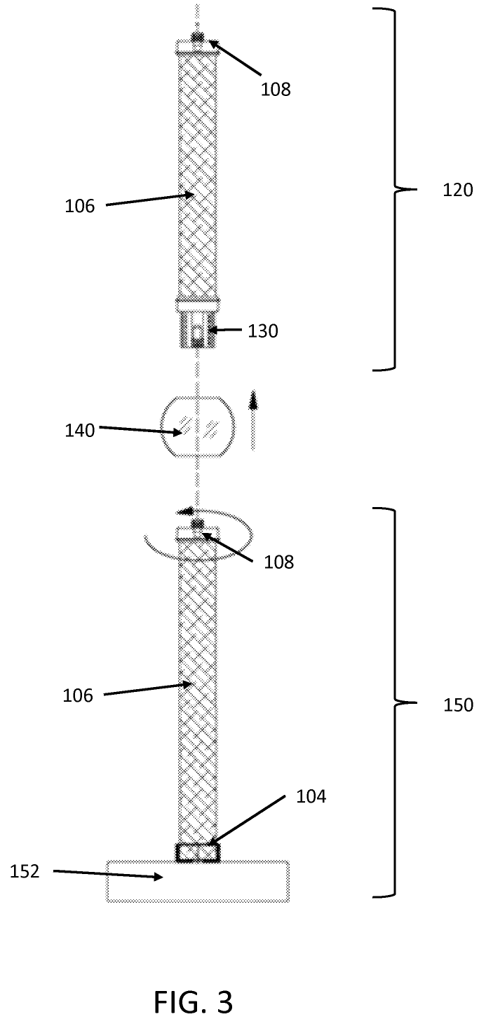

FIG. 3 depicts an illustrative view of a portion of a modular lighting fixture assembly showing the connection of a mounting segment 150 and a rope segment 120. A lighting assembly 130 may be positioned at the junction of the segments, and a translucent bead 140 may be placed over the lighting assembly 130. The translucent bead 140 may be configured to diffuse light emitted by the lighting assembly 130 as described.

The second mounting segment 150 may be affixed to the rope segment 120. In some cases, the mounting segment 150 may be predominantly cylindrical in shape. The mounting segment 150 includes a rope strain relief 104 where it connects to the flexible sheath 106 of the rope segment 120. This rope strain relief 104 may help prevent damage to the internal components due to bending or tension at the connection point.

A mounting connection 152 may be provided at the base of the mounting segment 150 for securing the assembly to a surface such as a wall or ceiling. In some cases, the mounting connection 152 may include a removable plate for easier installation. This removable plate may be configured to be affixed to the surface first, allowing the rest of the mounting segment 150 to be attached afterwards, which may simplify the installation process. In some examples, the mounting canopy 152 dimensions of the mounting fixture may have a diameter of 8-3/8" x height of 1-5/8".

The mounting segment 150 may be configured to supply power to the rope segment 120 and any additional connected segments. In some cases, only one of the two mounting segments 110/150 may be configured to supply power.

The modular nature of the assembly, as illustrated in FIG. 3, may allow for easy customization of the lighting fixture length and configuration. Users may add or remove rope segments 120 as needed, while the mounting segment 150 provides a secure anchor point and power source for the entire assembly.

### Example Assemblies

FIG. 4 depicts an illustrative view of a modular lighting fixture assembly 400 in accordance with an embodiment. The modular lighting assembly 400 comprises a series of rope segments 120 joined in series, with translucent beads 140 positioned between them. Mounting segments 110 and 150 may be coupled to either end of the modular lighting assembly 400 to affix it to a surface such as a wall or ceiling. FIG. 4 shows the system attached to a ceiling and the rope segments hanging down, draped like a necklace and then back to the ceiling.

In the view shown in FIG. 4, the modular lighting fixture assembly 400 is affixed to a ceiling, causing the assembly to sag into an arc. This configuration demonstrates the flexibility of the rope segments 120 and their ability to adapt to various installation requirements.

The rope segments 120 may be connected to each other using the male connectors 108 and female connectors 134 as described in previous figures and description. This modular design allows for customization of the overall length of the modular lighting fixture assembly 400 by adding or removing rope segments 120 as needed.

The translucent beads 140 positioned between the rope segments 120 may serve to diffuse the light emitted by the lighting assemblies 130 contained within each rope segment 120. This diffusion may create a more uniform and aesthetically pleasing light distribution along the length of the modular lighting fixture assembly 400.

The mounting segments 110 and 150 at either end of the modular lighting fixture assembly 400 may serve multiple purposes. In addition to securing the assembly to a surface, these mounting segments may also supply power to the connected rope segments 120. In some cases, one or both of the mounting segments 110 and 150 may contain a power supply unit configured to convert alternating current to direct current for powering the LEDs within the lighting assemblies 130.

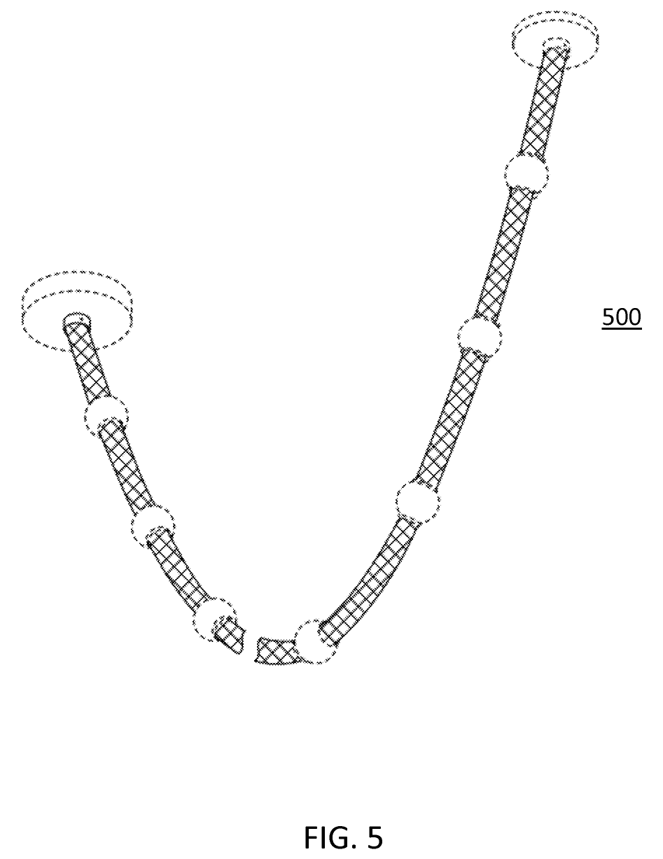

FIG. 5 depicts an illustrative view of a mounted modular lighting fixture assembly in accordance with an embodiment 500. As illustrated the assembly may mount to the ceiling in two locations. The two mounting segments may or may not have similar dimensions. In some embodiments, a mounting segment which is supplying power to the assembly may be larger than a mounting segment not supplying power.

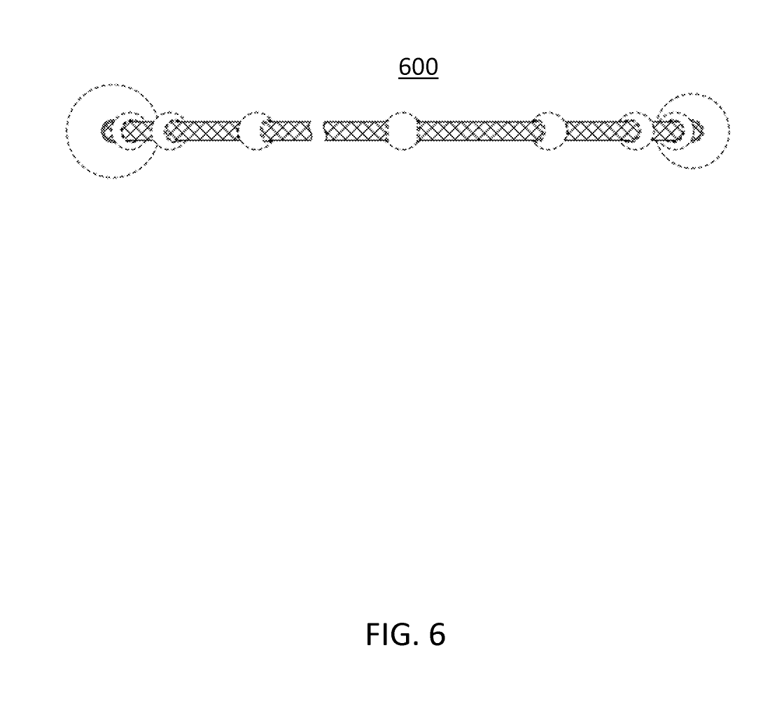

FIG. 6 depicts an illustrative view of a mounted modular lighting fixture assembly 600 in accordance with an embodiment. As illustrated, the assembly may mount at two locations on a wall. The assembly may be configured to hang between the two locations.

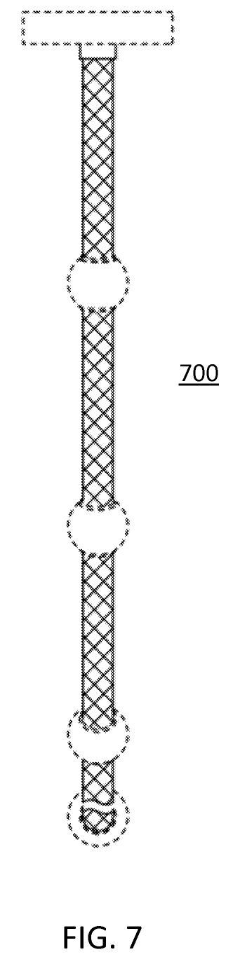

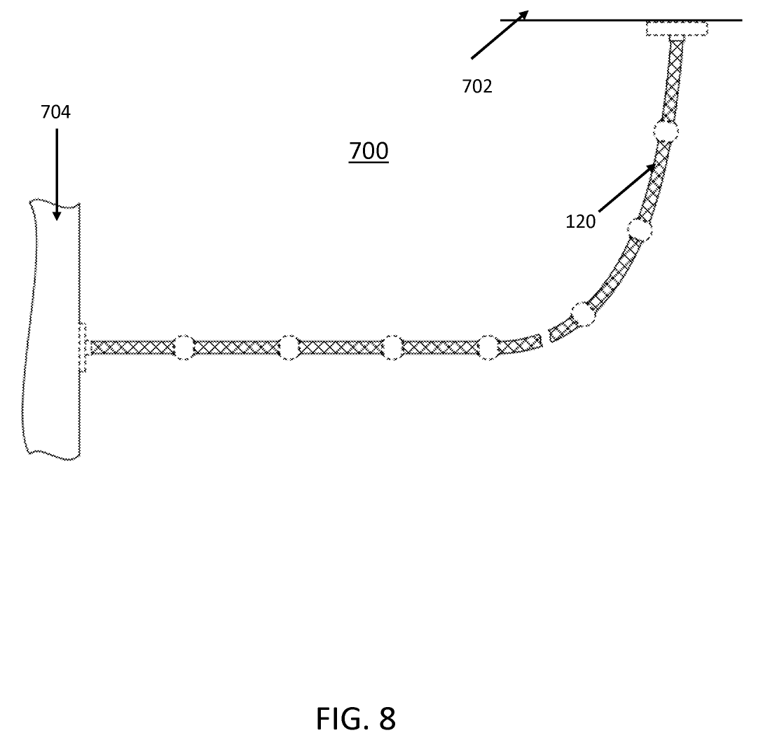

FIG. 7 depicts a side view and FIG. 8 depicts a front view of a mounted modular lighting fixture assembly in accordance with an embodiment. As illustrated, the assembly 700 may mount one end at one location on the ceiling 702 and a second end at a second location on the wall 704. Any combination or permutation of mounting on an object or surface may be arranged due to the flexibility of the rope structure described and the mounting assemblies.

In some embodiments, individual rope segments 120 in a modular lighting fixture assembly may be configured with unique properties to produce a specific aesthetic. For example, rope segments 120 may vary in length and/or flexibility to produce a desired form. Furthermore, the configuration of lighting assemblies 130 may vary between individual rope segments 120.

In some examples, the modular lighting fixture assembly has a length of ten feet. In some examples, the modular lighting fixture assembly has a length of one foot, two feet, three feet, four feet, five feet, six feet, seven feet, eight feet, nine feet, ten feet, fifteen feet, seventeen feet, twenty feet, or any other length of assembly.

### Other Examples

In some cases, the modular lighting fixture assembly 400 may further comprise a controller configured to adjust brightness or color of the LEDs within the lighting assemblies 130. This controller may be integrated into one of the mounting segments 110 or 150, or it may be a separate component connected, either wired or wirelessly, to the assembly. The controller may allow users to customize the lighting output of the modular lighting assembly 400 to suit various environments or preferences and include computer components, chips, drivers, embedded logic, software, or other programming needed to send instructions to the LED components to turn on, off, change color, etc.

The mounting segments 110 and 150 may incorporate various attachment mechanisms to secure the modular lighting fixture assembly 400 to a surface. While the illustrated embodiment in FIG. 4 included a semi-permanent installation by which may be screwed to the surface, other mounting options are considered. In some cases, the mounting segment 110 or 150 may be a hook, loop, or magnet for easy relocation of the assembly. This feature may allow users to quickly reposition the modular lighting fixture assembly 400 without the need for permanent installation, providing flexibility in lighting design and arrangement. In some embodiments, the two mounting segments 110/150 may be distinct. For example, the mounting segment providing power may be affixed to the surface using screws, while the second mounting segment may be a hook.

The flexible nature of the rope segments 120, combined with the modular design of the assembly, allows the modular lighting assembly 400 to be configured in various shapes and lengths. This versatility may make the assembly suitable for a wide range of applications, from residential spaces to commercial or hospitality settings, where customizable and adaptable lighting solutions are desired.

In some cases, the flexible sheath of the modular lighting fixture assembly may be woven. A woven flexible sheath may provide additional durability and flexibility to the rope segments, allowing for easier manipulation and installation of the lighting fixture. In some examples, the woven material is or includes plastic, nylon, cotton, Kevlar, carbon fiber, rubber, lycra, or any other kind of flexible material.

In some aspects, the flexible sheath of the rope segments may be configured to hold a moldable shape, allowing users to bend and position the lighting assembly into various configurations that maintain their form. This feature may enhance the versatility of the modular lighting fixture, enabling it to adapt to different spatial requirements or create custom lighting designs. The sheath may incorporate materials such as malleable metals, shape-memory alloys, or reinforced polymers to achieve this moldable characteristic. For example, the sheath may include embedded wire or thin metal strips that can be bent and retain their shape. Alternatively, the sheath may be constructed from a thermoplastic polymer that softens when heated and holds its shape when cooled. Other potential materials may include silicone-based compounds with added stiffening agents, or composite materials that combine flexible and rigid components to create a balance between moldability and structural integrity. The specific choice of material may depend on factors such as the desired level of flexibility, durability requirements, and manufacturing considerations.

The translucent beads used in the modular lighting fixture assembly 400 may have various characteristics to enhance the aesthetic and functional aspects of the lighting. In some cases, the translucent beads may be tinted. Tinted translucent beads may allow for customization of the light color emitted by the lighting assembly, creating different ambiances or matching specific design requirements.

The translucent beads may have different types of openings to accommodate various installation methods. In some cases, the translucent bead may have a keyed opening to affix in one or more given orientations. This keyed opening may ensure that the translucent bead is positioned correctly relative to the lighting assembly, potentially directing light in a specific manner or aligning decorative features of the bead. Alternatively, the translucent beads may be configured to freely rotate around the lighting assembly.

The opacity of the translucent beads may be varied to achieve different lighting effects. In some cases, the translucent beads may have varying levels of opacity. Beads with different opacity levels may be used within the same modular lighting fixture assembly to create patterns or gradients of light intensity along the length of the fixture.

The material composition of the translucent beads may vary. In some cases, the translucent beads may be made of glass. Glass beads may provide a high-quality appearance and excellent light transmission properties. In other cases, the translucent beads may be made of plastic. Plastic beads may offer benefits such as lighter weight, increased durability, and potentially lower cost.

The shape and size of the translucent beads may also vary. In some cases, the translucent beads may have different shapes and sizes within the same modular lighting fixture assembly. This variation in bead shape and size may create visual interest and allow for customization of the lighting fixture's appearance to suit different design aesthetics.

The arrangement of the light-emitting diodes (LEDs) within the lighting assembly may be configured in various ways. In some cases, the LEDs may be arranged in wrapped rows. This configuration may allow for a higher density of LEDs within the lighting assembly, potentially increasing the overall light output of the modular lighting fixture assembly.

These variations and additional embodiments of the modular lighting fixture assembly provide flexibility in design and functionality, allowing for customization to suit various aesthetic preferences and lighting requirements in different environments.

### Computer Examples

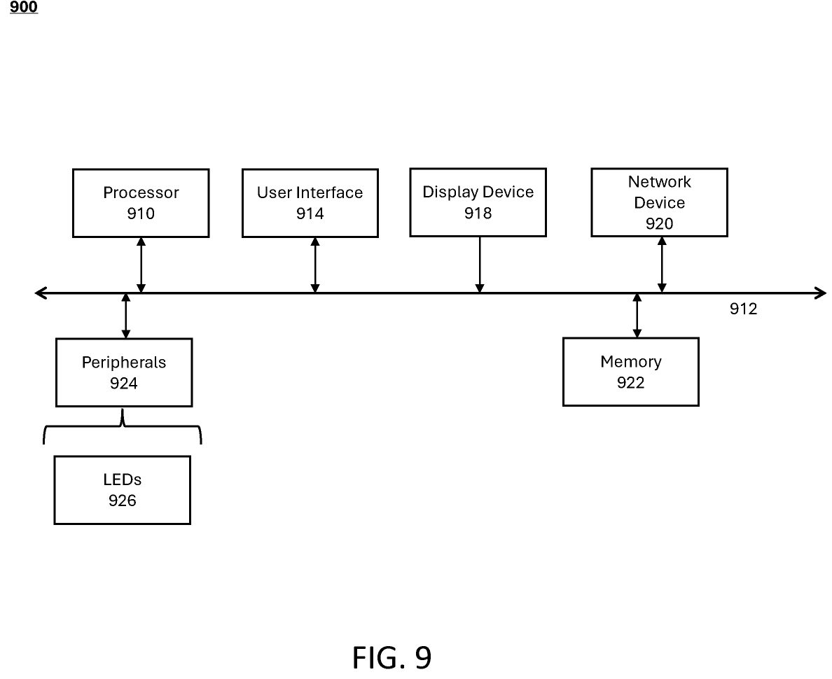

FIG. 9 shows an example computing device 900 which may be used in the systems and methods described herein. For example, the computing device 900 may serve as the lighting controller and/or an LED driver as described herein. In the example computer 900, a CPU or processor 910 is in communication, via a bus 912 or other communication, with a user interface 914. The user interface may include example input device such as a keyboard, mouse, touchscreen, button, joystick, or other user input device(s). The CPU 910 may interface to a display device 918 such as a screen. In some embodiments, the user interface 914 and/or the display device 918 may be related to an external device remotely interfaced to the computer 900. The computing device 900 shown in FIG. 9 also includes a network interface 920 which is in communication with the CPU 910 and other components. The network interface 920 may allow the computing device 900 to communicate with other computers, databases, networks, user devices, or any other computing capable devices. In some examples, additionally or alternatively, the method of communication may be through WIFI, cellular, Bluetooth Low Energy, wired communication, or any other kind of communication. In some examples, additionally or alternatively, the example computing device 900 includes peripherals 924 also in communication with the processor 910. In some examples, the peripherals 924 may include the LEDs 926 or lighting elements in the lighting assembly. In some examples, the computing device 900 include a non-transitory memory 922 in communication with the processor 910. In some examples, additionally or alternatively, this memory 922 may include instructions to execute commands associated with lighting control.

### CONCLUSION

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

Unless the context clearly requires otherwise, throughout the description, the words "comprise," "comprising," and the like are to be construed in an inclusive sense as opposed to an exclusive or exhaustive sense; that is to say, in a sense of "including, but not limited to." Words using the singular or plural number also include the plural or singular number respectively. Additionally, the words "herein," "hereunder," "above," "below," and words of similar import refer to this application as a whole and not to any particular portions of this application. When the word "or" is used in reference to a list of two or more items, that word covers all of the following interpretations of the word: any of the items in the list, all of the items in the list and any combination of the items in the list.

Although certain presently preferred implementations of the embodiments have been specifically described herein, it will be apparent to those skilled in the art to which the embodiments pertain that variations and modifications of the various implementations shown and described herein may be made without departing from the spirit and scope of the embodiments. Accordingly, it is intended that the embodiments be limited only to the extent required by the applicable rules of law.

What is claimed is:

1. A modular lighting fixture assembly, comprising:
a plurality of rope segments, each rope segment comprising:
a flexible sheath,
a lighting assembly disposed at one end of each of the plurality of the rope segments, the lighting assembly comprising at least one light emitting diode (LED). and
at least one connector configured to electrically and mechanically couple to an adjacent rope segment,
at least one translucent bead configured to surround the lighting assembly; and
a first mounting segment configured to supply power to the plurality of rope segments and to secure the modular lighting fixture assembly to a surface.

2. The modular lighting fixture assembly of claim 1, further comprising a second mounting segment, wherein the first mounting segment and second mounting segment are coupled to opposite ends of the modular lighting assembly.

3. The modular lighting fixture assembly of claim 1, wherein the flexible sheath is woven.

4. The modular lighting fixture assembly of claim 1, wherein the at least one connector comprises a male connector at one end of the rope segment and a female connector at an opposite end of the rope segment.

5. The modular lighting fixture assembly of claim 1, wherein the lighting assembly comprises a plurality of LEDs arranged in a linear configuration.

6. The modular lighting fixture assembly of claim 1, wherein the translucent bead is removable from the lighting assembly.

7. The modular lighting fixture assembly of claim 1, wherein the first mounting segment comprises a power supply unit configured to convert alternating current to direct current for powering the LEDs.

8. The modular lighting fixture assembly of claim 1, further comprising a controller configured to adjust brightness or color of the LEDs.

9. The modular lighting fixture assembly of claim 1, wherein the first mounting segment further comprises a strain relief element.

10. The modular lighting fixture assembly of claim 1, wherein the flexible sheath comprises electrical conductors for transmitting power between adjacent rope segments.

11. The modular lighting fixture assembly of claim 1, wherein the translucent bead is configured to diffuse light emitted by the lighting assembly.

12. The modular lighting fixture assembly of claim 1, wherein the modular lighting fixture assembly is configurable into various lengths by connecting different numbers of rope segments.
